(19) United States
(12) Patent Application Publication
(10) Pub. No.: US 2005/0274204 A1
(43) Pub. Date: Dec. 15, 2005

(54) Arrangement for plankton net

(76) Inventor: Svenn Linde, Trondheim (NO)

Correspondence Address: DENNISON, SCHULTZ, DOUGHERTY & MACDONALD, 1727 KING STREET, SUITE 105, ALEXANDRIA, VA, 22314, US

(21) Appl. No.: 10/518,381

(22) PCT Filed: Mar. 24, 2004
(86) PCT No.: PCT/NO04/00082

§ 371 Date: Dec. 29, 2004

(30) Foreign Application Priority Data
Jun. 27, 2003 (NO) 20032965

(51) Int. Cl. G01N 1/12

(52) U.S. Cl. 73/863.23; 73/864.63

(57) ABSTRACT

Arrangement for a plankton net, for collecting plankton-containing water from arbitrary ocean depths. It has a net compartment 11, which can be lowered to a desired water depth and which has a closing member 17 that is arranged to enclose a collected amount of water. A sieving member 14 is attached to the net compartment for discharge of water. The arrangement includes a member 25, which is arranged to keep the inlet of the entrance of the net compartment (14) closed until the sampling is to be conducted.

The invention relates to plankton net as stated in the introductory part of claim 1.

### BACKGROUND

Submersible equipment for collecting water and plankton samples are known. For instance there is known a plankton net, which is operated with vertical movement from a boat. The plankton net is attached to a wire by means of a “crowfoot”, and can thus be lowered to the desired maximal depth, after which it can be pulled upwards through the water for collection of material. By mounting a trip gear between the wire and the net, the net can be closed on its way up, so that samples are collected only from a small part of the water column. This can be accomplished by releasing a weight (“messenger”) down along the wire, which then hits a trip gear and closes the net. With this equipment, it is difficult to close the net at a particular depth. By change of trip depth, the time lag for the release of the messenger must be recalculated. In addition, the attachment lines in the crowfoot will disturb the opening of the net.

A plankton net named “Multi Plankton Sampler” is also known, whereby net pouches are opened before hauling the sampler through the water, either horizontally or vertically, for collecting water with plankton at a certain depth. This equipment has a complicated motorized mechanism for remote opening and closure of the net pouches.

From U.S. Pat. No. 3,466,782 (Stuart) there is known a plankton net where the entrance has a revolvable hatch, which can be closed after filling of a net compartment. However, this equipment does not give satisfactory control of the water intake, so that water can be collected from a certain water depth. In addition, it needs a complex, spring-driven propeller mechanism for forcing water into the net compartment.

### OBJECT

The main object of the invention is to create a plankton net, which has a design that is as simple as possible, and which is easy to use. The object is to be able to perform the sampling substantially cheaper, and simultaneously with better accuracy, than with prior art equipment. It will be an advantage if this plankton net can be used with existing carrying equipment. Furthermore, it is desirable to be able to perform sampling at an accurately defined water depth. The net opening should be free and uninterrupted. Along with the sampling, data should simultaneously be collected by means of CTD-instrument (measurement of conductivity, temperature and density). It should also be possible to combine usage of the plankton net according to the invention, with a prior art water sampler. It is also an object to create a plankton net, which is flexible, so that one may perform both individual as well as parallel hauls of the net through the water.

### THE INVENTION

The invention is stated in claim 1. It can for instance be used with a known water sampling system of which a central carrier is configured to carry a number of water bottles in a rosette formation about a central carrier and, where for each water sampling position, there is arranged a remotely releasable gripping mechanism, which can hold a ring or the like, in a releasable manner. The arrangement according to the invention is intended for mounting in such a position on the central carrier. Additional details will appear from the following description.

Favourable details of the invention in claim 1 are set forth in claims 2-8. Further details and description of the operation will be apparant from the following example.

### EXAMPLE

In the following, the invention is described with reference to the drawings, where

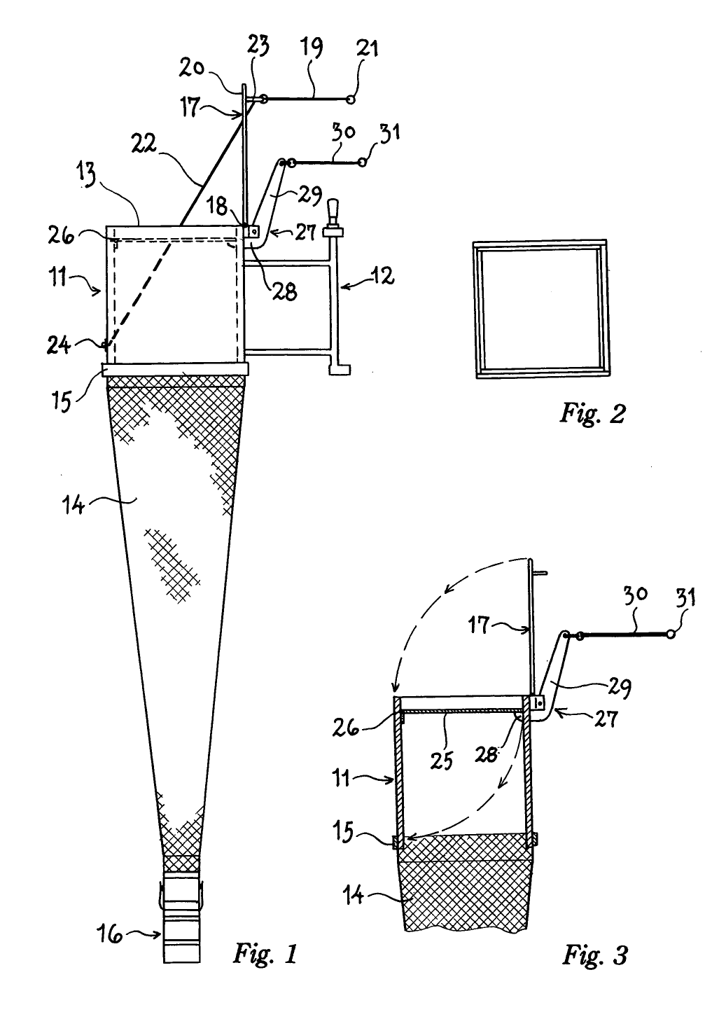

FIG. 1 is a side view of an embodiment of a plankton net according to the invention, arranged hanging in the sea,

FIG. 2 is a top plan view of the net compartment, and

FIG. 3 is a vertical section view through the net compartment of FIG. 1, with the outer and inner lid in initial position, before the intake of a plankton sample.

FIG. 1 and FIG. 2 illustrate a net compartment 11 with a quadratic box shape. The net compartment 11 is provided with a mounting bracket 12 on one side, for releasable mounting onto a central shank of a water sampling system. Such a shank, with a number of unreleasable grippers for rings or similar attachment bodies is known and will not be described further.

The net compartment 11 is made of plastic plates with a quadratic, plane aperture edge 13 and open bottom, where a downward-hanging sieving net pouch 14 is attached. The pouch in the example is made of a net, of which the mesh-width can be 15 to 500 microns. The net pouch 14 can be screwed onto the net compartment 11 with rails 15 of an appropriate material.

The net pouch 14 is funnel-shaped and has a collecting cup 16 at the lower end. The collecting cup 16 can be removed from the net pouch 14 and transferred to a laboratory for sample analysis.

The net compartment 11 has an combined upper or outer lid 17, which is hinged at the side edge 18 at the mounting bracket 12. In the deployment position, the outer lid 17 is held in an open (vertical in the drawing) position by a wire 19, which is attached at the outer edge 20 and provided with a ring 21 at the free end. It can also have an inserted ring, which makes the wire flexible. At deployment, the ring 21 is releasably anchored to a gripper on the carrier system (not shown). The outer lid 17 is held open against the force of a flexible string or a helical spring 22, which is strapped between a mounting bracket 23 on the outer lid 17, and an anchorage point 24 at the front edge of the net compartment 11.

FIG. 3 illustrates how the net compartment 11 is arranged when able to collect plankton from a certain water depth. Right under the outer lid 17, a lower or inner lid 25 is pivotable attached, and hinged at the front edge 26 of the net compartment 11, so that it covers the aperture of the net compartment in its closed initial position. The inner lid 25 is kept closed by a J-formed locking arm 27, which is supported at its curve, so that the short part 28 extends inwards under the edge of the inner lid 25, while the stem 29 extends upwards and is held outwardly pivoted by a wire 30. The wire 30 has a ring 31 at the free end, which in use can be attached to a gripper on the carrier system (not shown) in a manner corresponding to ring 21.

### MODE OF OPERATION

One or more net compartments 11 are attached to a shank (not shown), with the rings 21 and 31 anchored to the shank's releasable grippers. The outer lid 17 and the inner lid 25 will thus be in the position shown in FIG. 3.

When the plankton net has been lowered to a relevant sampling depth, the mechanism that holds the ring 31 is remotely tripped. This opens the inner lid 25, and plankton-containing water is let into the plankton net. After sufficient inflow of water has occured, e.g. by pulling the plankton net through the water, the outer lid 17 is closed by tripping the ring 21. Hence the plankton sample remains enclosed inside the net compartment 11 and the net pouch 14, and can be brought up to the surface.

Independent of this, water samples can be collected with known equipment attached to the same carrier and releasing system.

1. Arrangement for a plankton net, for collecting plankton-containing water from arbitrary ocean depths, with a net compartment (11) that can be lowered to a desired water depth and which has a closing member (17) that is arranged to enclose a collected amount of water, and where a sieving member (14) is attached to the net compartment for discharge of water, characterized in that it comprises a member (25), which is arranged to keep the inlet of the entrance of the net compartment (14) closed until sampling is to be conducted.

2. Arrangement according to claim 1, characterized in that the net compartment (11) has a plane intake aperture (13), and that at this intake aperture, an outer lid (17) is attached at an outer edge of the aperture by a hinge attached to a side of the outer edge, and with a holding mechanism (19, 21) for holding the outer lid in an open initial position the holding mechanism being arranged to be tripped remotely.

3. Arrangement according to claim 2, characterized in that the outer lid (17) is biased towards a closed position by a biasing member (22).

4. Arrangement according to claim 2, characterized in that it has an inner lid (25) placed on the inside of the outer lid (17) by hinged joint on a side edge (26) of the aperture of the net compartment (11), where the inner lid (25) is able to be opened inwards into the compartment, but is kept closed by a remotely releasable locking mechanism (30, 31).

5. Arrangement according to claim 4, characterized in that the inner lid (25) is biased towards the open inwards pivoted position.

6. Arrangement according to claim 2, characterized in that the net compartment (11) is of a box Shaped, tight material, which has a bottom (14) of sieving material that extends out from the net compartment (11) in a pouch-shape.

7. Arrangement according to claim 6, characterized in that the bottom of the compartment is funnel-shaped with a detachable collecting cup (16) at the free end.

8. Arrangement according to claim 2, characterized in that the net compartment (11) is provided with members (12) for attachment to a carrier system, which has remotely operated tripping members for activation of the closing members.
